(19) United States
(12) Patent Application Publication
(10) Pub. No.: US 2007/0296883 A1
(43) Pub. Date: Dec. 27, 2007

(54) Array substrate for liquid crystal display device and method of fabricating the same

(75) Inventors: Ki-Young Kwon, Daegu (KR); Kwang-Hee Hwang, Daegu (KR)

Correspondence Address: MORGAN LEWIS & BOCKIUS LLP, 1111 PENNSYLVANIA AVENUE NW, WASHINGTON, DC, 20004, US

(73) Assignee: LG.Philips LCD Co., Ltd.

(21) Appl. No.: 11/637,814

(22) Filed: Dec. 13, 2006

(30) Foreign Application Priority Data
Jun. 27, 2006 (KR) 2006-0058231

(51) Int. Cl. G02F 1/136

(52) U.S. Cl. 349/43

(57) ABSTRACT

An array substrate for liquid crystal display devices includes first and second gate lines spaced apart from each other, a common line between the first and second gate lines parallel to the first and second gate lines, a data line crossing the first and second gate lines to define first and second pixel regions with respect to the common line, a first thin film transistor at a crossing portion of the first gate line and the data line, a second thin film transistor at a crossing portion of the second gate line and the data line, a first pixel electrode connected to the first thin film transistor in the first pixel region, and a second pixel electrode connected to the second thin film transistor in the second pixel region, wherein the first and second pixel electrodes have a symmetric shape with respect to the common line.

The present invention claims the benefit of Korean Patent Application No. 10-2006-058231, filed in Korea on Jun. 27, 2006, which is hereby incorporated by reference.

### BACKGROUND OF THE INVENTION

1. Field of the Invention

The present invention relates to a liquid crystal display (LCD) device, and more particularly, to an array substrate for an LCD device that has a high aperture and a method of fabricating the same.

2. Discussion of the Related Art

Generally, an LCD device uses optical anisotropy and the polarization properties of liquid crystal molecules to display images. Liquid crystal molecules that are thin and long have directionality. The alignment direction of the liquid crystal molecules may be controlled by applying an electric field to the liquid crystal molecules. As the intensity of the electric field changes, the alignment of the liquid crystal molecules changes accordingly. Because the refraction of the incident light through liquid crystals depends on the orientation of the liquid crystal molecules, images may be displayed by controlling the intensity of the incident light.

Furthermore, the LCD device includes a color filter substrate having a color filter and a common electrode, an array substrate having a pixel electrode, a liquid crystal layer between the color filter substrate and the array substrate. An LCD device has a good transmittance and has a relatively high aperture ratio because the LCD device is driven by a vertical electric field generated between the common electrode and the pixel electrode.

Generally, the pixel electrode and the common electrode constitute a liquid crystal capacitor. A storage capacitor is connected to the liquid crystal capacitor so that a voltage applied to the liquid crystal capacitor can be maintained until a next signal is applied to the liquid crystal capacitor. A storage capacitor may be formed in two ways. First, the storage capacitor may be of a storage-on-common type wherein one of capacitor electrodes of the storage capacitor is connected to a common line to which a common voltage is applied. Second, it may be of a storage-on-gate type wherein a portion of a (n−1)th gate line is utilized for one of the capacitor electrodes of the storage capacitor for a nth gate line.

In the storage-on-gate type, an additional common line is unnecessary because a low level voltage of a gate voltage is utilized for a storage capacitor voltage. However, there are problems including an interference problem due to coupling of the gate signal. On the other hand, in the storage-on-common type, there is no interference in the gate signal. Furthermore, there is an advantage that an enough storage capacitor can be obtained. However, the aperture ratio is reduced due to a light leakage.

Active matrix LCD (AM-LCD) devices are commonly used. AM-LCD devices have thin film transistors (TFTs) disposed in a matrix and pixel electrodes connected to the TFTs. AM-LCD devices have been developed because of their high resolution and superiority in displaying moving images.

FIG. 1 is a schematic plan view showing a storage-common-type array substrate for an active matrix liquid crystal device according to the related art. In FIG. 1, a plurality of gate lines 20 are formed along a first direction on a substrate 10. A plurality of data lines 30 are formed along a second direction crossing the first direction to define a plurality of pixel regions “P.”

A thin film transistor “T” is formed at crossing of each of the gate lines 20 and each of the data lines 30. A pixel electrode 60 is connected to the thin film transistor “T” in each of the pixel region “P.” Furthermore, a plurality of common lines 40 are formed along the first direction to be parallel to the gate lines 20. These common lines 40 pass through the pixel regions “P.”

FIG. 2 is an exploded view of an area “II” of FIG. 1. In FIG. 2, a gate electrode 24 is connected to the gate line 20. A source electrode 26 is connected to the data line 30. A drain electrode 28 is spaced apart from the source electrode 26. Here, the source electrode 26 and the drain electrode 28 have a space therebetween with respect to the gate electrode 24. Furthermore, a semiconductor layer 32 having an island shape is disposed over the gate electrode 24. The gate electrode 24, the semiconductor layer 32, the source electrode 26, and the drain electrode 28 constitute a thin film transistor “T.” A passivation layer (not shown) is formed on the thin film transistor “T” and a drain contact hole 57 is formed in the passivation layer. The pixel electrode 60 is electrically connected to the drain electrode 28 via the drain contact hole 57.

Here, an overlapping region of the pixel electrode 60 and the common line 40 constitutes a storage capacitor “Cst.” A portion of the common line 40 overlapping with the pixel electrode 60 functions as a first capacitor electrode. A portion of the pixel electrode 60 overlapping with the common line 40 functions as a second capacitor electrode. Accordingly, the first capacitor electrode, the second capacitor electrode, and an insulating layer (not shown) between the first capacitor electrode and the second capacitor electrode constitute a storage capacitor “Cst.”

Here, the size of the pixel electrode 60 in the pixel region “P” is proportional to the aperture ratio. However, in the storage-on-common type, the common line 40 overlaps with the pixel electrode 60 in the pixel region “P.” Therefore, the aperture ratio in the storage-on-common type storage capacitor “Cst” is reduced.

FIGS. 3A to 3C are schematic cross-sectional views taken along a line “III-III” of FIG. 2 illustrating a method of fabricating an array substrate for an LCD device according to the related art. In FIG. 3A, the gate electrode 24 and the common line 40 are formed on the substrate 10. A gate insulating layer 45 is formed on the gate electrode 24 and the common line 40.

In FIG. 3B, the semiconductor layer 32 is formed by sequentially forming an active layer 32a and an ohmic contact layer 32b on the gate insulating layer 45. The source electrode 26 and the drain electrode 28 spaced apart from each other are formed on the semiconductor layer 32. In this step, a portion of the ohmic contact layer 32b between the source electrode 26 and the drain electrode 28 is removed to expose a portion of the active layer 32a corresponding to the portion of the ohmic contact layer 32b. The exposed portion of the active layer 32a is defined as a channel “ch.” The gate electrode 24, the semiconductor layer 32, the source electrode 26, and the drain electrode 28 constitute a thin film transistor “T.”

In FIG. 3C, a passivation layer 55 is formed on the thin film transistor “T.” In this step, a drain contact hole 57 is formed by exposing a portion of the drain electrode 28 in the passivation layer 55. Next, a pixel electrode 60 is formed on the passivation layer 55 and is connected to the drain electrode 28 via the drain contact hole 57. An overlapping region of the common line 40 and the pixel electrode 60 with the gate insulating layer 45 and the passivation layer 55 therebetween constitutes a storage capacitor “Cst.” Here, a portion of the common line 40 overlapping with the pixel electrode 60 functions as a first capacitor electrode. A portion of the pixel electrode 60 overlapping with the common line 40 functions as a second capacitor electrode. Accordingly, the storage capacitor “Cst” of the storage-on-common type is completed.

FIG. 4 is an exploded view of a region “IV” of FIG. 3. In FIG. 4, a storage-on-common type storage capacitor includes a portion of the common line overlapping with the pixel electrode as a first capacitor electrode, a portion of the pixel electrode overlapping with the common line, and an insulating layer between the common line and the pixel electrode. In the storage-on-common type storage capacitor, there is a distortion between the voltage applied to the common line 40 and the voltage applied to the pixel electrode 60. Therefore, it is difficult to control the liquid crystal corresponding to the common line 40 and the pixel electrode 60. Accordingly, there is light leakage in both sides “LR” of the common line 40. Consequently, a brightness of a black image increases, resulting in a reduction in the contrast ratio.

Furthermore, if the aperture ratio is increased by reducing the width of the common line 40 in the pixel region “P,” the resistance of the common line 40 increases, which leads to a voltage drop. On the other hand, when the width of the common line increases, the supply of the storage voltage becomes unstable and the aperture ratio decreases.

### SUMMARY OF THE INVENTION

Accordingly, the present invention is directed to an array substrate for a liquid crystal display device and method of fabricating the same that substantially obviates one or more problems due to limitations and disadvantages of the related art.

An object of the present invention is to provide an array substrate for an LCD device and a method of fabricating the same wherein the contrast ratio is improved by reducing the signal distortion between the common line and the pixel electrode and by reducing the light leakage.

Another object of the present invention is to provide an array substrate for an LCD device and a method of fabricating the same wherein the image quality is improved and the aperture ratio is improved as the storage voltage is stably provided in the common line by reducing the limitation of the width of the common line. Two pixels are formed as a couple to have a symmetry structure, and a common line is disposed at an axis of symmetry of the two pixels.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the array substrate for a liquid crystal display device includes first and second gate lines spaced apart from each other and disposed on a substrate, a common line between the first and second gate lines being disposed parallel to the first and second gate lines, a data line crossing the first and second gate lines respectively to define first and second pixel regions with respect to the common line, a first thin film transistor at a crossing portion of the first gate line and the data line, a second thin film transistor at a crossing portion of the second gate line and the data line, a first pixel electrode connected to the first thin film transistor in the first pixel region, and a second pixel electrode connected to the second thin film transistor in the second pixel region, wherein the first and second pixel electrodes have a symmetric shape with respect to the common line, and wherein respective end portions of the first and second pixel electrodes overlap with the common line.

In another aspect, the method of fabricating an array substrate for a liquid crystal display device includes forming first and second gate lines spaced apart from each other and first and second gate electrodes respectively connected to the first and second gate lines, forming a common line between the first and second gate lines being disposed parallel to the first and second gate lines, forming a data line crossing the first and second gate lines respectively to define first and second pixel regions with respect to the common line, first and second source electrodes connected to the data line, and first and second drain electrodes respectively spaced apart from the first and second electrodes, and forming a first pixel electrode connected to the first drain electrode in the first pixel region, and a second pixel electrode connected to the second drain electrode in the second pixel region, wherein the first and second pixel electrodes have a symmetric shape with respect to the common line, and wherein respective end portions of the first and second pixel electrodes are overlapping with the common line.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a schematic plan view showing a storage-common-type array substrate for an active matrix liquid crystal device according to the related art.

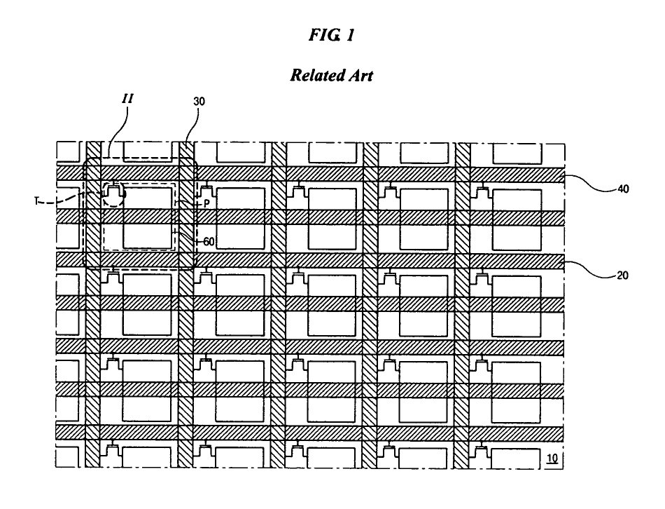

FIG. 2 is an exploded view of an area “II” of FIG. 1 according to the related art.

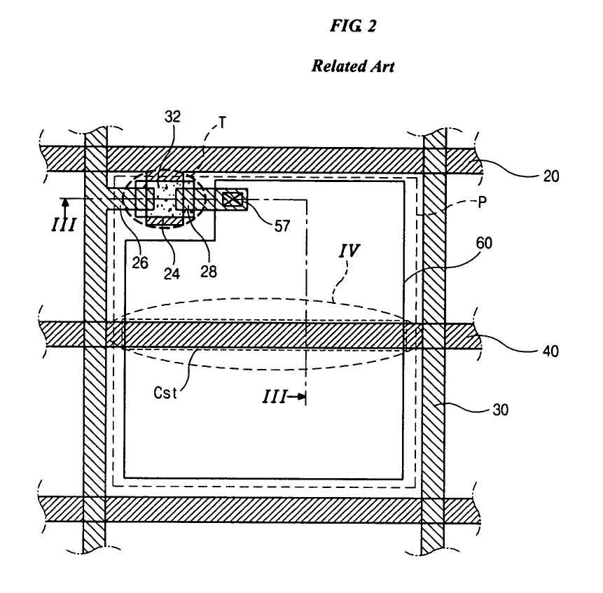

FIGS. 3A to 3C are schematic cross-sectional views taken along a line “III-III” of FIG. 2 illustrating a method of fabricating an array substrate for an LCD device according to the related art.

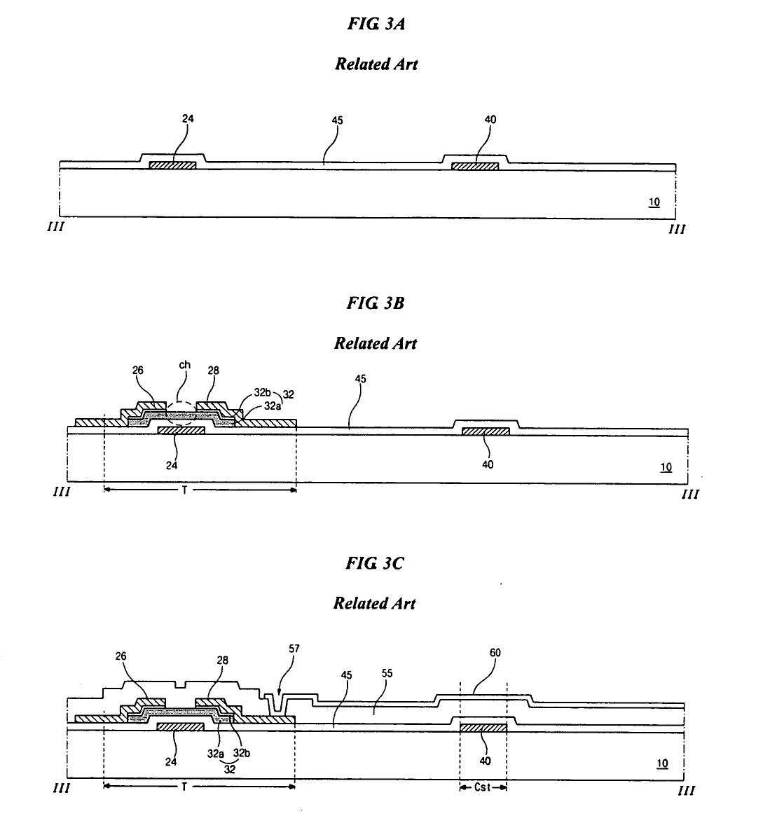

FIG. 4 is an exploded view of a region “IV” of FIG. 3 according to the related art.

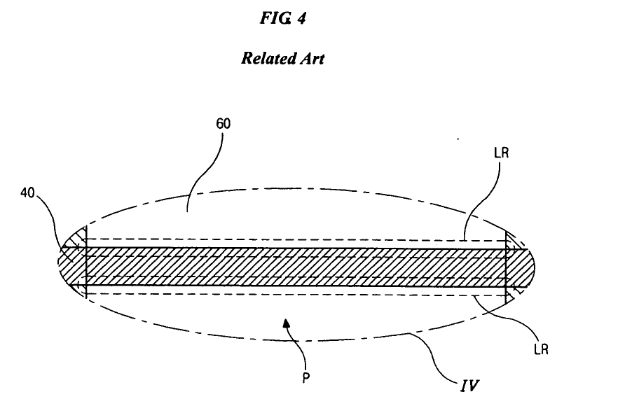

FIG. 5 is a schematic plan view of an array substrate for an LCD device according to an exemplary embodiment of the present invention.

FIG. 6 is an exploded view of two pixel regions of a region “VI” of FIG. 5 according to the exemplary embodiment of the present invention.

FIG. 7 is an exploded view of a region “VII” of FIG. 6 according to the exemplary embodiment of the present invention.

FIGS. 8A to 8E are schematic cross-sectional views taken along a line “VIII-VIII” of FIG. 6 illustrating a method of fabricating an array substrate for an LCD device according to the exemplary embodiment of the present invention.

### DETAILED DESCRIPTION OF THE PREFERRED EMBODIMENTS

Reference will now be made in detail to the preferred embodiments of the present invention, examples of which are illustrated in the accompanying drawings.

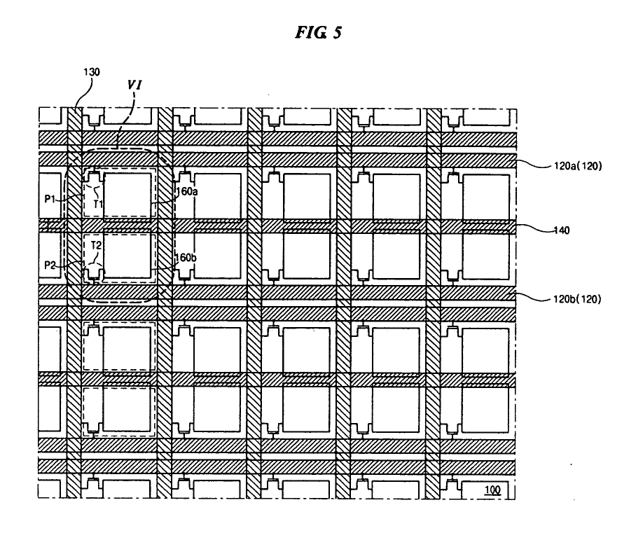

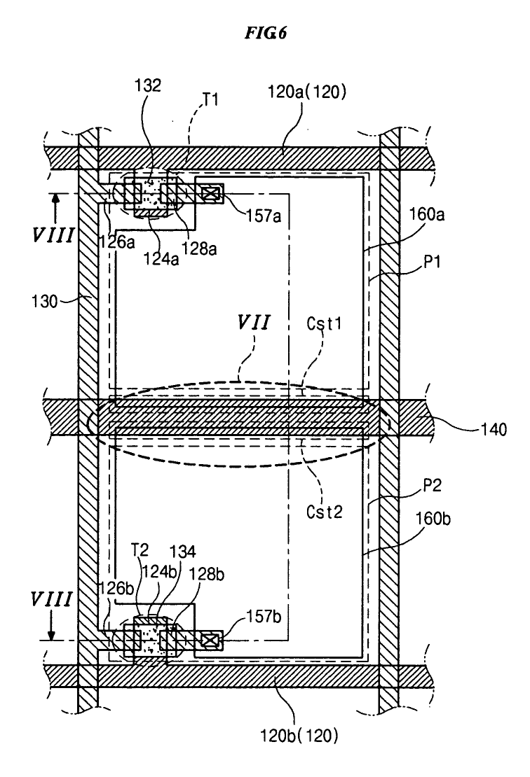

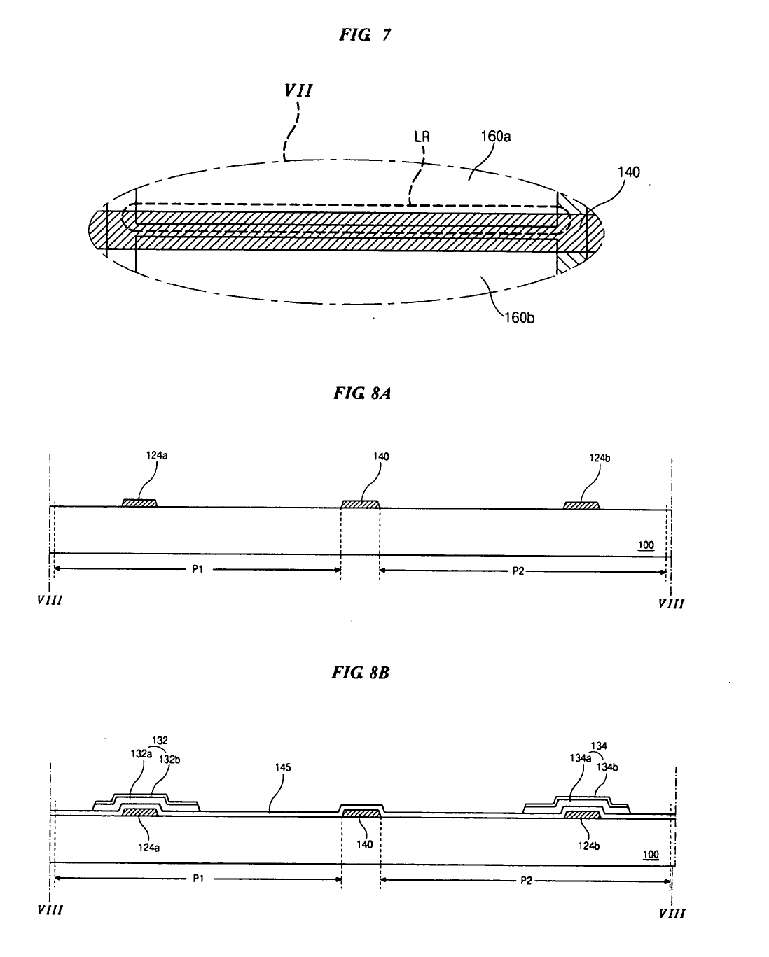

FIG. 5 is a schematic plan view of an array substrate for an LCD device according to an exemplary embodiment of the present invention, FIG. 6 is an exploded view of two pixel regions of a region “VI” of FIG. 5 according to the exemplary embodiment of the present invention, and FIG. 7 is an exploded view of a region “VII” of FIG. 6 according to the exemplary embodiment of the present invention. In FIGS. 5, 6, and 7, a plurality of gate lines 120 are formed along a first direction on a substrate 100, and a plurality of data lines 130 are formed along a second direction crossing the second direction. The gate lines 120 include first and second gate lines 120a and 120b spaced apart from each other. A first gate electrode 124a extends from the first gate line 120a, and a second gate electrode 124b extends from the second gate line 120b. Here, the first and second gate electrodes 124a and 124b face each other and have a symmetric shape.

Furthermore, a first source electrode 126a and a first drain electrode 128a are spaced apart from each other with respect to the first gate electrode 124a. A second source electrode 126b and a second drain electrode 128b are spaced apart from each other with respect to the second gate electrode 124b. Here, the first and second source electrodes 126a and 126b extend from the data line 130. Furthermore, first and second semiconductor layers 132 and 134 having an island shape are disposed over the first and second gate electrodes 124a and 124b, respectively. The first gate electrode 124a, the first semiconductor layer 132, the first source electrode 126a, and the first drain electrode 128a constitute a first thin film transistor “T1.” The second gate electrode 124b, the second semiconductor layer 134, the second source electrode 126b, and the second drain electrode 128b constitute a second thin film transistor “T2.”

The first and second thin film transistors T1 and T2 face each other and have a symmetric shape. First and second pixel electrodes 160a and 160b are connected to the first and second thin film transistor T1 and T2, respectively. Although not shown, a passivation layer is formed on the first and second thin film transistors T1 and T2. First and second drain contact holes 157a and 157b are formed in the passivation layer to expose the first and second drain electrodes 128a and 128b, respectively.

Furthermore, a common line 140 is disposed along the first direction. The common line 140 is disposed at the axis of the symmetry between the first and second thin film transistors T1 and T2. Crossing regions of the first gate line 120a, the common line 140, and the data lines 130 crossing the first line 120a is defined as the first pixel region “P1.” Crossing regions of the second gate line 120b, the common line 140, and the data lines 130 crossing the second line 120b is defined as the second pixel region “P2.”

Meanwhile, end portions of the first and second pixel electrode 160a and 160b adjacent to the common line 140 overlap with the common line 140. The overlapping regions between the first pixel electrode 160a and the common line 140 and between the second pixel electrode 160b and the common line 140 constitute first and second storage capacitors “Cst1” and “Cst2” with an insulating layer (not shown) therebetween, respectively. Here, a portion of the common line 140 of the storage capacitor “Cst” functions as a first capacitor electrode. Furthermore, portions of the first and second pixel electrodes 160a and 160b function as second capacitor electrodes, respectively.

The storage capacitor Cst according to the present invention is a storage-on-common type storage capacitor. The common line 140 is disposed at the axis of symmetry of the first and second pixel electrodes 160a and 160b, symmetrically disposed in the first and second pixel regions P1 and P2.

Furthermore, as two pixels adjacent to each other share the common line 140, the light leakage “LR” occurs in only one of end portion of the common line 140. This is because the two pixels are independently driven and because the light leakage occurs in the driven pixel.

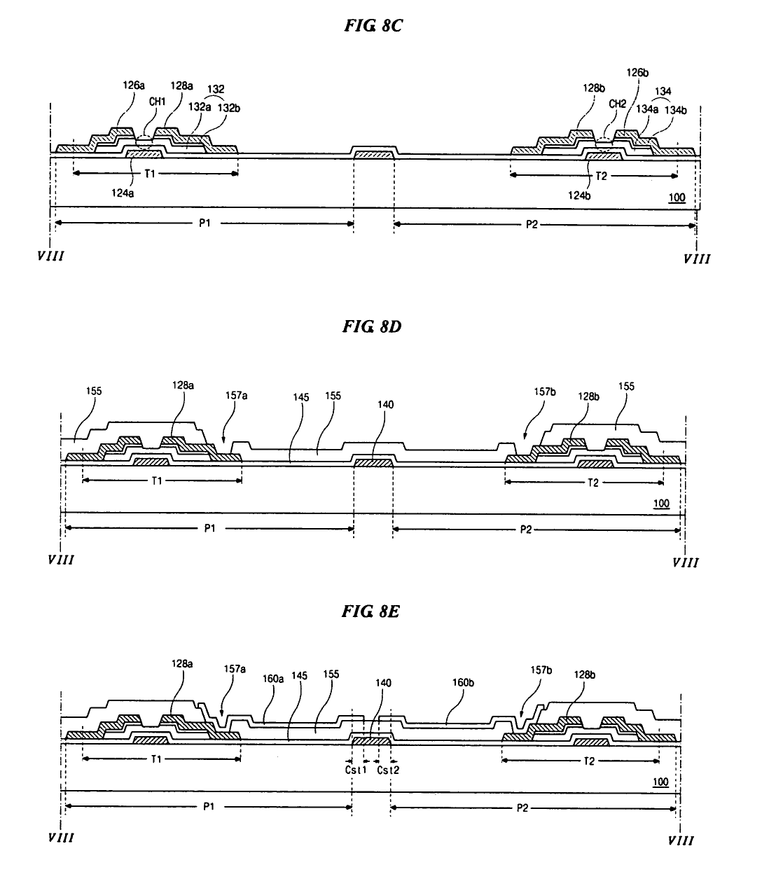

FIGS. 8A to 8E are schematic cross-sectional views taken along a line “VIII-VIII” of FIG. 6 illustrating a method of fabricating an array substrate for an LCD device according to the exemplary embodiment of the present invention.

In FIG. 8A, the first gate electrode 124a, the second gate electrode 124b, and the common line 140 between the first and second gate electrodes 124a and 124b are formed on the substrate 100 in which the first pixel region “P1” and the second pixel region “P2” are defined. Here, the first and second gate electrodes 124a and 124b are disposed in the first and second pixel regions P1 and P2, respectively. The common line 140 is disposed at a boundary between the first and second pixel regions P1 and P2.

For example, the first gate electrode 124a, the second gate electrode 124b, and the common line 140 includes a conductive metallic material such as aluminum (Al), copper (Cu), Al alloy, or a double material layer including the conductive metallic material as a bottom layer.

In FIG. 8B, a gate insulating layer 145 is formed on the first and second gate electrodes 124a and 124b and the common line 140. The first and second semiconductor layers 132 and 134 are formed on the gate insulating layer 145 over the first and second gate electrodes 124a and 124b, respectively. The gate insulating layer 145 may include an insulating inorganic material such as silicon oxide (SiOx) or silicon nitride (SiNx). The first semiconductor layer 132 includes first and second active layers 132a and 132b of an intrinsic amorphous silicon material. The second semiconductor layer 134 includes first and second ohmic contact layers 134a and 134b of a doped amorphous silicon material.

In FIG. 8C, the first source electrode 126a and the first drain electrode 128a are formed on the first ohmic contact layer 132b over the first gate electrode 124a. A second source electrode 126b and a second drain electrode 128b are formed on the second ohmic contact layer 134b over the second gate electrode 124b. In this step, portions of the first and second ohmic contact layers 124a and 124b corresponding to spaces between the first source and first drain electrodes 126a and 126b and between the second source and second drain electrodes 128a and 128b are removed to open portions of the first and second active layers 132a and 132b, respectively. The open portions of the first and second active layers 132a and 132b are defined as first and second channel regions “CH1 and CH2,” respectively. For example, the first source and first drain electrodes 126a and 128a, and the second source and second drain electrodes 126b and 128b include a conductive metallic material such as molybdenum (Mo), tungsten (W) or nickel (Ni). Consequently, the first gate electrode 124a, the first semiconductor layer 132, the first source electrode 126a, and the first drain electrode 128a constitute a first thin film transistor “T1.” The second gate electrode 126b, the second semiconductor layer 134, the second source electrode 126b, and the second drain electrode 128b constitute a second thin film transistor “T2.”

In FIG. 8D, a passivation layer 155 is formed on the first and second thin film transistors “T1 and T2.” In this step, the passivation layer 155 is etched to form first and second contact holes 157a and 157b that expose portions of the first and second drain electrodes 128a and 128b. For example, the passivation layer 155 includes an insulating inorganic material such as the silicon oxide (SiOx) or the silicon nitride (SiNx) or an insulating organic material such as benzocyclobutene (BCB) or acrylic resin.

In FIG. 8E, first and second pixel electrodes 160a and 160b are formed in the first and second pixel regions “P1 and P2,” respectively. The first and second pixel electrodes 160a and 160b are connected to the first and second drain electrodes 128a and 128b via the first and second drain contact holes 157a and 157b, respectively. Here, end portions of the first and second pixel electrodes 160a and 160b adjacent to the common line 140 overlap with the common line 140. The overlapping regions of the first pixel electrode 160a and the common line 140 and of the second pixel electrode 160b and the common line 140 constitute first and second storage capacitors “Cst1” and “Cst2” with the gate insulating layer 145 and the passivation layer 155 therebetween, respectively. For example, the first and second pixel electrodes 160a and 160b include a transparent conductive material such as indium tin oxide (ITO) or indium zinc oxide (IZO).

According to the present invention, the light leakage can be reduced by reducing a distortion phenomenon between the common line and the pixel electrode. Furthermore, as two pixels adjacent to each other share the common line, the light leakage occurs in one of end portions of the common line, whereas, in the storage-on-common type storage capacitor according to the related art, the light leakage occurs at both end portions of the common line. Second, since the common line is disposed at boundary between the pixel regions, the aperture ratio due to the width of the common line can be improved. Therefore, the image quality can be improved because the limitation of the width of the common line is relieved, and the common voltage can be stably applied to the common line. Third, the reduction of the aperture region can be prevented because the common line is disposed at the boundary of the pixel regions.

It will be apparent to those skilled in the art that various modifications and variations can be made in the array substrate for liquid crystal display device and method of fabricating the same of the present invention without departing from the spirit or scope of the invention. Thus, it is intended that the present invention cover the modifications and variations of this invention provided they come within the scope of the appended claims and their equivalents.

What is claimed is:

1. An array substrate for a liquid crystal display device, comprising:
first and second gate lines spaced apart from each other and disposed on a substrate;
a common line between the first and second gate lines being disposed parallel to the first and second gate lines;
a data line crossing the first and second gate lines respectively to define first and second pixel regions with respect to the common line;
a first thin film transistor at a crossing portion of the first gate line and the data line;
a second thin film transistor at a crossing portion of the second gate line and the data line;
a first pixel electrode connected to the first thin film transistor in the first pixel region; and
a second pixel electrode connected to the second thin film transistor in the second pixel region,
wherein the first and second pixel electrodes have a symmetric shape with respect to the common line, and wherein respective end portions of the first and second pixel electrodes overlap with the common line.

2. The substrate according to claim 1, wherein the first thin film transistor includes a first gate electrode connected to the first gate line, a first semiconductor layer over the first gate line, and a first source electrode and a first drain electrode spaced apart from each other with respect to the first gate electrode, and the second thin film transistor includes a second gate electrode connected to the second gate line, a second semiconductor layer over the second gate line, and a second source electrode and a second drain electrode spaced apart from each other with respect to the second gate electrode.

3. The substrate according to claim 1, further comprising an insulating layer between the common line and the pixel electrode.

4. The substrate according to claim 3, wherein the overlapping portion of the common line and the first pixel electrode with the insulating layer constitutes a first storage capacitor, and the overlapping portion of the common line and the second pixel electrode with the insulating layer constitutes a second storage capacitor.

5. The substrate according to claim 4, wherein the first and second storage capacitors have substantially similar capacities.

6. A method of fabricating an array substrate for a liquid crystal display device, comprising:
forming first and second gate lines spaced apart from each other and first and second gate electrodes respectively connected to the first and second gate lines;
forming a common line between the first and second gate lines being disposed parallel to the first and second gate lines;
forming a data line crossing the first and second gate lines respectively to define first and second pixel regions with respect to the common line, first and second source electrodes connected to the data line, and first and second drain electrodes respectively spaced apart from the first and second electrodes; and
forming a first pixel electrode connected to the first drain electrode in the first pixel region, and a second pixel electrode connected to the second drain electrode in the second pixel region,
wherein the first and second pixel electrodes have a symmetric shape with respect to the common line, and wherein respective end portions of the first and second pixel electrodes are overlapping with the common line.

7. The method according to claim 6, further comprising forming a gate insulating layer on the first and second gate lines and the first and second gate electrodes.

8. The method according to claim 6, wherein forming the common line is simultaneously performed with forming the first and second gate lines and the first and second gate electrodes.

9. The method according to claim 8, further comprising forming a passivation layer on the data line, the first and second source electrodes, and the first and second drain electrodes.

10. The method according to claim 9, wherein the overlapping portion of the common line and the first pixel electrode with the gate insulating layer and the passivation layer constitutes a first storage capacitor, and the overlapping portion of the common line and the second pixel electrode with the gate insulating layer and the passivation layer constitutes a second storage capacitor.

11. The method according to claim 9, wherein forming the passivation layer includes forming first and second drain contact holes that respectively expose portions of the first and second drain electrodes.

12. The method according to claim 1, wherein the first pixel electrode is connected to the first drain electrode via the first drain contact hole, and the second pixel electrode is connected to the second drain electrode via the second drain contact hole.
